(19) United States
(12) Patent Application Publication
(10) Pub. No.: US 2009/0099948 A1
(43) Pub. Date: Apr. 16, 2009

(54) Two-Stage Estimation of Real Estate Price Movements for High Frequency Tradable Indexes in a Scarce Data Environment

(76) Inventors: David Geltner, Carlisle, MA (US); Sheharyar Bokhari, Cambridge, MA (US)

Correspondence Address: CHOATE, HALL & STEWART LLP, TWO INTERNATIONAL PLACE, BOSTON, MA, 02110, US

(21) Appl. No.: 12/206,255

(22) Filed: Sep. 8, 2008

Related U.S. Application Data
(60) Provisional application No. 60/973,821, filed on Sep. 20, 2007.
(60) Provisional application No. 61/041,306, filed on Apr. 1, 2008.

(51) Int. Cl. G06Q 40/00

(52) U.S. Cl. 705/35

(57) ABSTRACT

Indexes of commercial property prices face much scarcer transactions data than housing indexes, yet the advent of tradable derivatives on commercial property places a premium on both high frequency and accuracy of such indexes. The dilemma is that with scarce data a low-frequency return index (such as annual) is necessary to accumulate enough sales data in each period. This invention presents an approach to address this problem using a two-stage procedure with frequency conversion, by first estimating lower-frequency indexes staggered in time, and then applying a generalized inverse estimator to convert from lower to higher frequency return series. The two-stage procedure can improve the accuracy of high-frequency indexes in scarce data environments, and also can mitigate an errors-in-variables problem that arises at very high frequency even with plentiful data (e.g., monthly indexes). In this paper the method is demonstrated and analyzed via simulation analysis and by application to empirical commercial property repeat-sales data.

This application claims priority to U.S. provisional application Ser. Nos. 60/973,821 filed Sep. 20, 2007 and 61/041,306 filed Apr. 1, 2008, the contents of both of which are incorporated herein by reference. This application is related to U.S. application Ser. No. 11/445,401 filed Jul. 10, 2007.

### BACKGROUND OF THE INVENTION

In the world of transaction price indexes used to track market movements in real estate, it is a fundamental fact of statistics that there is an inherent trade-off between the frequency of a price-change index and the amount of “noise” or “error” in the periodic price-change or “capital return” estimates. Geltner & Ling (2006) discussed the trade-off that arises, as higher-frequency indexes are more useful, but noisy indexes are less useful. The contents of all of the references listed in the attached bibliography are incorporated herein by reference. More generally, the fundamental problem is transaction data scarcity for index estimation, and this is a particular problem with commercial property price indexes, because commercial transactions are much scarcer than housing transactions. Also, sufficient good quality hedonic data is particularly lacking for most commercial properties, making repeat-sales indexes the only practical option in many circumstances, which can further reduce the sample size especially in the early years of an index. But the greater utility of higher frequency indexes has recently come to the fore with the advent of tradable derivatives based on real estate price indexes. Over-the-counter trading of the IPD Index of commercial property in the UK took off in 2004 and has been growing strongly since then. The S&P/Case-Shiller House Price Index (CSI) has been traded on the Chicago Mercantile Exchange since early 2006, while trading on the appraisal-based NCREIF Property Index (NPI) of commercial property in the US commenced in the summer of 2007. The Moody's/REAL Commercial Property Price Index, launched in September 2007 based on Real Capital Analytics Inc (RCA) data, is also a tradable index and is, like the CSI, a repeat-sales transaction price-based index. Tradability increases the value of frequent, up-to-date information about market movements, because the lower transactions and management costs of the derivatives compared to direct cash investment in physical property allows profit to be made synthetically based on the market movements tracked by the index. This is so even if the index underlying the derivative is lagged, as the derivative contracts' prices can reflect the effect of the lag. Thus, for example, movements in a high-frequency transactions price-based index can inform contemporaneous movements in the prices of continuously-traded derivatives based on a more sluggish or lower-frequency appraisal-based index such as the NPI. To illustrate, suppose the transaction index indicates the market dropped 4%. This might cause a 4% drop in the price of a one-year contract on the appraisal-based index if the lag in the index is less than one year, even though it might cause only a much smaller price drop in an appraisal-based contract that expires within a quarter or two (as the more sluggish index will take longer than that to register the full market movement).

Higher-frequency indexes also allow more frequent “marking” of derivatives contracts, which in turn allows smaller margin requirements, which increases the utility of the derivatives. For example, margin requirements in a swap contract are dictated by the likely net magnitude of the next payment owed, which is essentially a function of the periodic volatility of the index, and volatility (per period) is a decreasing function of index frequency (simply because there is less time for market price change deviations around prior expectations to accumulate between index return reports that cover shorter time spans). Lower margin requirements allow greater use of synthetic leverage which facilitates greater liquidity in the derivatives market.

Goetzmann (1992) introduced into the real estate literature what is perhaps the major approach to date for addressing small-sample problems in price indexes, the use of biased ridge or Stein-like estimators in a Bayesian framework. Other approaches that have been explored in recent years include various types of parsimonious regression specifications that effectively parameterize the historical time dimension, as well as procedures that make use of temporal and spatial correlation in real estate markets. See, for example, Schwann (1998), McMillen & Dombrow (2001), and Clapp (2004), among others. A recent overview is in Pace & LeSage (2004). Some such techniques show promise, but are perhaps more appropriate in the housing market than in commercial property markets. Spatial correlation is more straightforward in housing markets, and housing sales density produces sufficient sales observations in smaller geographic units. Another concern that is of particular importance in indexes supporting derivatives trading is that the index estimation procedure should minimize the constraints placed on the temporal structure and dynamics of the estimated returns series, allowing each consecutive periodic return estimate to be as independent as possible, in particular so as to avoid lag bias and to capture turning points in the market even if these are inconsistent with prior temporal patterns. This is particularly important to allow the derivatives to hedge the type of risk that traders on the short side of the derivatives market are typically trying to manage. For example, developers or investment managers seek to hedge against exposure to unexpected and unpredictable turning points or movements in the commercial property market.

### SUMMARY OF THE INVENTION

The present invention is a method for generating a higher frequency tradable index of real estate price movements including running a first stage regression to optimize a real estate price change index at a sufficiently low frequency to eliminate most noise to generate a low frequency index. A series of the low frequency indexes is produced in different versions that have regularly staggered starting dates corresponding to the frequency of a desired higher frequency index. Thereafter, a second stage regression is run to convert the staggered series of low frequency indexes to the higher frequency index.

In a preferred embodiment, a suitable low frequency index is yearly and a suitable higher frequency index is quarterly.

### BRIEF DESCRIPTION OF THE DRAWING

FIG. 1 is a graph showing four staggered annual indexes.

FIG. 2 is a graph of true versus estimated underlying staggered annual indexes.

FIG. 3 is a graph of a New York office property price index directly estimated and derived along with staggered annual indexes.

FIG. 4 is a graph of MPGIE-based ATQ for southern California retail property superimposed on the underlying staggered annual indexes.

FIG. 5 is a table comparing 16 quarterly indexes in data-scarce markets.

FIG. 6 is a graph of a San Francisco office property price index directly estimated and derived along with staggered annual indexes.

FIG. 7 is an MPGIE-based QTM two-stage monthly index for all U.S. commercial property superimposed on underlying staggered quarterly indexes.

FIG. 8 is a graph of monthly comparison of two-stage QTM versus direct-monthly estimation.

FIG. 9 is a table showing monthly price change return statistics for two-stage QTM and direct-monthly index.

FIG. 10 is a table showing pair-wise Granger Causality tests.

### DESCRIPTION OF THE PREFERRED EMBODIMENT

In the present application, we disclose a two-stage estimation procedure in which, after a first-stage regression is run to optimize the index at a sufficiently low frequency to eliminate most noise (recognizing the scarce data environment), a second-stage regression is performed to convert a staggered series of such low-frequency indexes to a higher-frequency index. The disclosed procedure is optimal in the sense that it minimizes additional (second stage) noise and does not introduce artificial index price lag bias or smoothing (as would be the case with simple smoothing or rolling techniques, and with some of the time-parameterization techniques noted earlier). While in the present application we apply the second-stage frequency conversion to traditional repeat-sales indexes estimated at the lower frequency, in principle the 2-stage procedure can be applied with any methodology for estimating the first-stage (lower-frequency) indexes as long as the lower-frequency estimation can be staggered regularly in time.

While the resulting high-frequency index does not have as high a signal/noise ratio (SNR) as the underlying low-frequency indexes, it can have a higher SNR than direct high-frequency estimation, with the advantage of the greater utility of the higher frequency. This suggests that it may be useful in the information marketplace to publish both the staggered low-frequency indexes and the higher-frequency second-stage derived index as supplemental information, either alone or along with directly-estimated high-frequency indexes, at least in markets where data is too scarce to rely solely on directly-estimated high-frequency indexes.

Furthermore, in the case of very high frequency indexing, such as monthly frequency, the two-stage procedure also helps to address an errors-in-variable problem in the time dummy-variables that are used to estimate longitudinal indexes. This problem arises from the fact that, even though the closing dates of transactions may be observed with very high accuracy, the time lapse between when the economic pricing decision was made and when the closing occurred is typically a difficult-to-observe length of time that varies randomly across transactions over a range of perhaps several weeks, enough to cause errors-in-variables at the monthly frequency. Thus, for monthly indexes the two-stage/frequency-conversion approach may be valuable even where data scarcity is not an issue and the high-frequency index can stand alone.

We will now introduce the two-stage/frequency-conversion procedure from the perspective of increasing index frequency in a data-scarce environment, in particular, for deriving a supplemental quarterly-frequency index from four underlying staggered annual-frequency indexes. This perspective is taken for illustrative purposes, and a later section will explore the other application noted previously, that of high-frequency indexing with plentiful data but subject to errors-in-variables regarding the timing of the transaction pricing decisions.

As noted, commercial property transaction price data in particular is scarce (e.g., compared to housing data). To the extent the market wants to trade specific segments, such as, say, New York office buildings or Southern California retail properties, the transaction sample becomes so small that we may need to accumulate a full year's worth of data before we have enough to produce a good transactions-based estimate of market price movement. This is the type of context in which we propose the following two-stage/frequency-conversion procedure to produce a quarterly index.

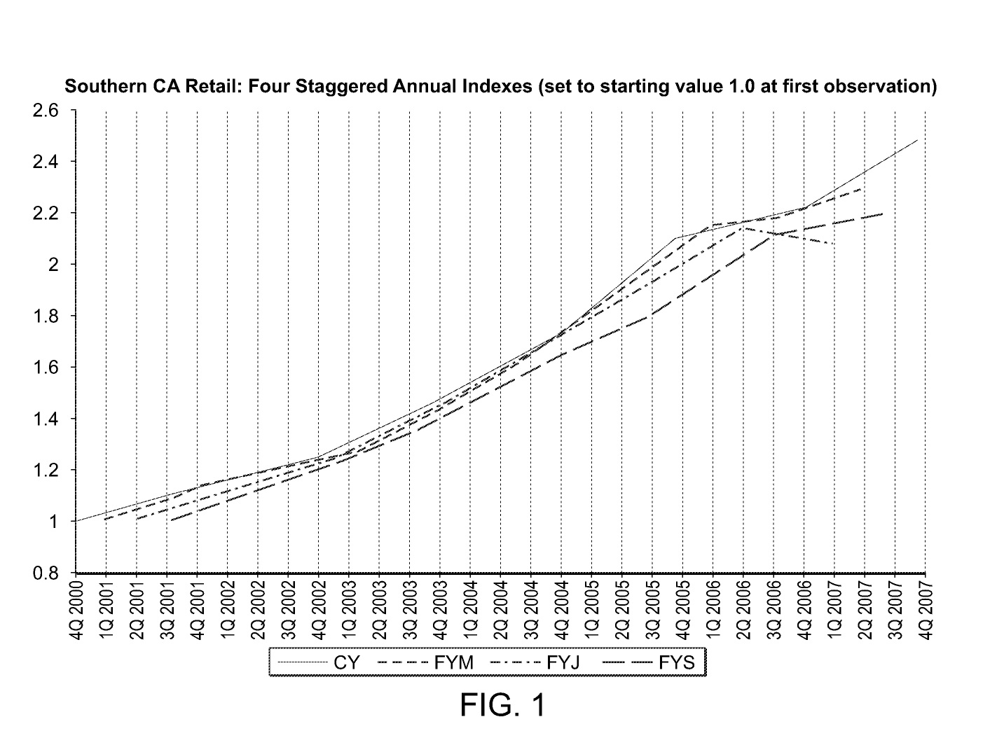

We begin by estimating annual indexes in four versions with quarterly staggered starting dates, beginning in January, April, July, and October. We label these four annual indexes as “CY”, “FYM”, “FYJ”, and “FYS” to refer to “calendar years” and “fiscal years” identified by their ending months. Each index is a true annual index, not a rolling or moving average within itself, but consisting of independent consecutive annual returns. That is, independent within each index. Obviously, there is temporal overlap across the indexes. The result will look something like what is pictured in FIG. 1 for an example index based on the Real Capital Analytics repeat-sales database for Southern California (Los Angeles & San Diego) retail property. If properly specified, these annual indexes have essentially no lag bias. Time-weighted dummy variables are used to eliminate temporal aggregation. For example, for the calendar year (CY) index beginning January 1^{st}, a repeat-sale observation of a property that is bought Sep. 30, 2004 and sold Sep. 30, 2007 has time-dummy values of zero prior to CY2004 and subsequent to CY2007, and dummy-variable values of 0.25 for CY2004, 1.0 for CY2005 and CY2006, and 0.75 for CY2007. This specification, attributable to Bryon & Colwell (1982), eliminates the averaging of the values across the years, and pegs the returns to end-of-year points in time. See Geltner & Pollakowski (2007) for more details. Each of these indexes also has as little noise as is possible given the amount of data that can be accumulated over the annual spans of time. A noise filter such as ridge regression can be helpful in this regard (as introduced into the real estate literature by Goetzmann, 1992), and has in fact been used in the indexes shown. As noted, the two-stage procedure does not constrain the methodology used to estimate the lower-frequency indexes, and various procedures might be employed to optimize the estimation of the lower-frequency indexes.

Next, a frequency-conversion is applied to this suite of annual-frequency indexes to obtain a quarterly-frequency price index implied by the four staggered annual indexes. We want to perform this frequency conversion in the most accurate way possible, with as little additional noise and bias as possible. How can we use those staggered annual indexes to derive an up-to-date quarterly-frequency index? Looking at the staggered annual-frequency index levels pictured in FIG. 1, one is tempted to try to construct a quarterly-frequency index by simply averaging across the levels of the four indexes at each point in time. (Try to fit a curve “between” the four index levels.) But such a process would entail a delay of three quarters in computing the most recent quarterly return (while we accumulate all four annual indexes spanning that quarter), which for derivatives trading purposes would defeat the purpose of the higher-frequency index. Such a levels-averaging procedure would also considerably smooth the true quarterly returns (it would effectively be a time-centered rolling average of the annual returns).

The approach we propose to the frequency-conversion procedure is a second-stage “repeat-sales” regression at the quarterly frequency using the four staggered annual indexes as the input data. As noted, the input annual indexes from the first stage do not need to be repeat-sales indexes, in principle. They could be any good transactions-price based type of index, such as a hedonic index. Each annual return on each of the four staggered indexes is treated as a “repeat-sale” observation in this second-stage regression. If we have T years of history, we will have 4T-3 such “repeat-sales” observations (the row dimension of the second-stage regression data matrix), and we will have 4T quarters for which we have time-dummies (the columns dimension in the regression data matrix, the quarters of history for which we want to estimate returns). We are missing “1^{st}-sales” observations for the first three quarters of the history, the quarters that precede the starting dates for all of the annual indexes other than the one that starts earliest in time (the CY index in our present example), as the staggered annual indexes each must start one quarter after the previous. Obviously, with fewer rows than columns in the estimation data matrix, our regression is “under-identified”, that is, the system has fewer equations than unknowns. We cannot simply drop out the first three quarters from the second-stage index, as that will then impute the first three annual returns to their respective quarters and thereby bias the estimation of all of the quarterly returns. Basic linear algebra tells us that such a system has an infinite number of exact solutions (that is, quarterly index return estimates that will cause the predicted values to exactly match the “repeat-sales” observations on the left-hand-side of the second-stage regression, i.e., a regression R² of 100%, a perfect fit to the data, the low-frequency index returns). However, of all of those infinite solutions, there is a particular solution that minimizes the variance of the estimated parameters, i.e., that minimizes the additional noise in the quarterly returns, noise added by the frequency-conversion procedure. This solution is obtained using what is called the “Moore-Penrose pseudoinverse” matrix of the data. This solution is “best” in the sense that it has the least variance (is most “precise”) and the least bias possible for a linear estimator. We shall refer to this frequency-conversion method as the “Moore-Penrose Generalized Inverse Estimator”, or MPGIE for short. See Appendix A for an introduction to the Moore-Penrose pseudoinverse and its role in solving the under-identified system. See Appendix B for a discussion of bias in the resulting estimator. As noted in Appendix A, it can be shown that, while the Moore-Penrose pseudoinverse estimator of the under-identified system is biased, the bias is minimized among the class of linear estimators (Chipman, 1964). That is, the Moore-Penrose is “Best Linear Minimum Bias Estimator” (BLMBE).

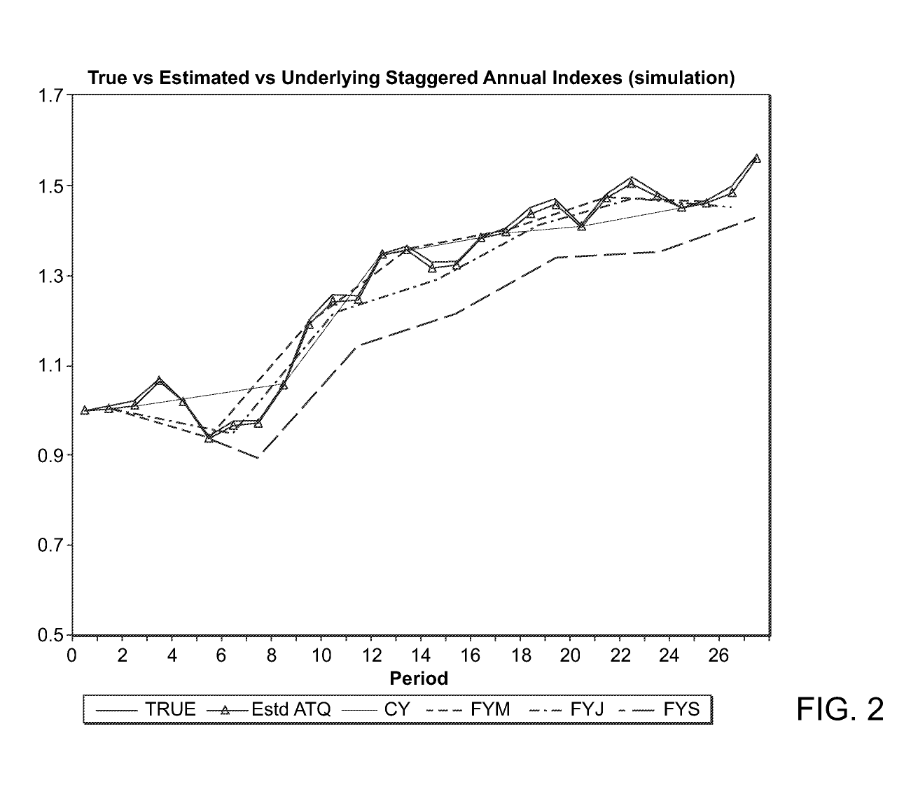

How good is the MPGIE as a frequency-conversion method? For practical purposes, it is quite good. It adds effectively very little noise or bias to the annual returns. This can be seen by numerical simulation. FIG. 2 depicts a typical randomly-generated history of true quarterly market values (the thick black line, which in the real world would be unobservable), the corresponding staggered annual index levels (thin, dashed lines, here without any noise, to reveal the noise added purely by the frequency-conversion second stage), and the resulting second-stage MPGIE-estimated quarterly index levels (thin red line with triangles, labeled “ATQ”). In FIG. 2 the first (CY) annual index starts arbitrarily at a value of 1.0, and the subsequent three staggered annual indexes are pegged to start at the interpolated level of the just-prior annual index at the time of the subsequent index's start date. This is merely a convention and does not impact the quarterly return estimates, as all indexes are only indicators of relative price movements across time, not absolute price levels. Clearly, the derived MPGIE quarterly index almost exactly matches the true quarterly market value levels. Numerous simulations of random histories and varying market patterns over time give similar results to those depicted in FIG. 2. The MPGIE-based frequency-conversion in itself appears to add only a little noise or bias to the staggered annual indexes.

Based on the foregoing argument, the 2-stage derived quarterly index (which we shall refer to here as the “ATQ”, for “annual-to-quarterly”) offers the prospect of being better than a directly-estimated single-stage quarterly index. However, in general it can't be as “good” as the annual-frequency indexes if we define the index quality by the signal/noise ratio. However, the ATQ will provide information more frequently than the annual indexes, and this may make the trade-off worthwhile. To see this, consider the following.

In the signal/noise ratio (SNR) the numerator is defined theoretically as the periodic return volatility of the (true) market prices, and the denominator is defined as the standard error in the estimated periodic return. The theoretical SNR cannot be observed or quantified in the real world, where the true market returns cannot be observed, and hence the true market volatility cannot be observed. Empirical estimates of the theoretical SNR are confounded by the fact that the volatility of any empirically estimated index will itself be “contaminated” by the noise in the estimated index. Nevertheless, the theoretical SNR is a useful construct for conceptual analysis purposes (and also in simulation analysis, where true returns can be simulated and observed). The MPGIE frequency-conversion procedure gives a SNR denominator for the ATQ which is not much larger than that of the underlying annual-frequency indexes (the standard error of the second-stage quarterly return estimate not much larger than that in the first-stage annual return estimates, as evident in the simulation depicted in FIG. 2 by the fact that the ATQ adds very little error). But the numerator of the SNR is governed by the fundamental dynamics of the (true) real estate market. These dynamics dictate that the periodic return volatility will be smaller for higher frequency returns. For example, if the market follows a random walk (serially uncorrelated returns), the quarterly volatility will be 1/SQRT(4)=½ the annual volatility. This means that, even if the SNR denominator did not increase at all, the SNR in the ATQ would be one-half that in the underlying annual indexes. If the market has some sluggishness or inertia (positive autocorrelation in the quarterly returns) then the SNR will be even more reduced in the ATQ below that in the annual indexes.

Importantly, the SNR of the 2-stage ATQ can still be greater than that of a directly-estimated (single-stage) quarterly index. To see this, suppose price observations occur uniformly over time. Then there will be four times as much data for estimating the typical annual return in the annual-frequency indexes compared to the typical quarterly return in the directly-estimated quarterly-frequency index. By the basic “Square Root of N Rule” of statistics, this implies that the directly-estimated quarterly index will tend to have SQRT(4)=2 times greater standard error in its (quarterly) return estimates than the annual indexes have in their (annual) return estimates. Thus, the SNR for the direct quarterly index will have a denominator twice that of the annual indexes. This compares to the 2-stage ATQ whose SNR denominator may be only slightly greater than in the annual indexes (as was suggested in the previous section, depicted in FIG. 2). Of course, either way of producing a quarterly index will still be subject to the same numerator in the theoretical SNR, which is purely a function of the true market volatility. Thus, while the 2-stage ATQ will have a lower SNR than the underlying annual-frequency indexes, it may have a higher SNR than a directly-estimated (1-stage) quarterly index. In data-scarce situations, this can make an important difference.

Importantly, while the ATQ does not have as good SNR as the annual indexes, it does provide more frequent returns than the annual indexes (quarterly instead of annual), and thereby does provide additional information. Among the four staggered annual indexes we do get new information every quarter, but that information is only for the entire previous 12-month span, which is not as useful as information about the most recent quarter itself, which is what is provided by the ATQ. For example, a turning point in the most recent quarter will not necessarily show up in the most recent annual index, as the latter is still influenced by market movement earlier in the 4-quarter span it covers. Thus, there is a useful trade-off between the staggered annual indexes and the derived ATQ: the ATQ gives up some SNR information usefulness in the accuracy of its return estimates, but in return provides higher frequency return information.

This trade-off suggests that it may make sense in practical applications to produce and publish both the staggered annual indexes and their implied MPGIE-based ATQ quarterly index. Whether the derivative market will want to actually trade contracts written on the ATQ is a question that only the market can decide. But in any case the ATQ will provide information useful to market participants and analysts.

To gain a more concrete feeling for the above-described methodology and application, consider two of the smaller (and therefore more data-scarce) markets among the 29 Moody's/REAL Commercial Property Price Indexes that are based on the RCA repeat-sales database: New York office properties, and Southern California retail properties. The Moody's/REAL Commercial Property Price Index is produced by Moody's Investor Services under license from Real Estate Analytics LLC (REAL). These two markets are selected here because they are representative of both the strengths and weaknesses of the 2-stage procedure. During the 2005-07 period the New York Office index averaged 25 transaction price observations (second-sales) per quarter, while the Southern California (Los Angeles & San Diego MSAs) index averaged 24 observations/quarter.

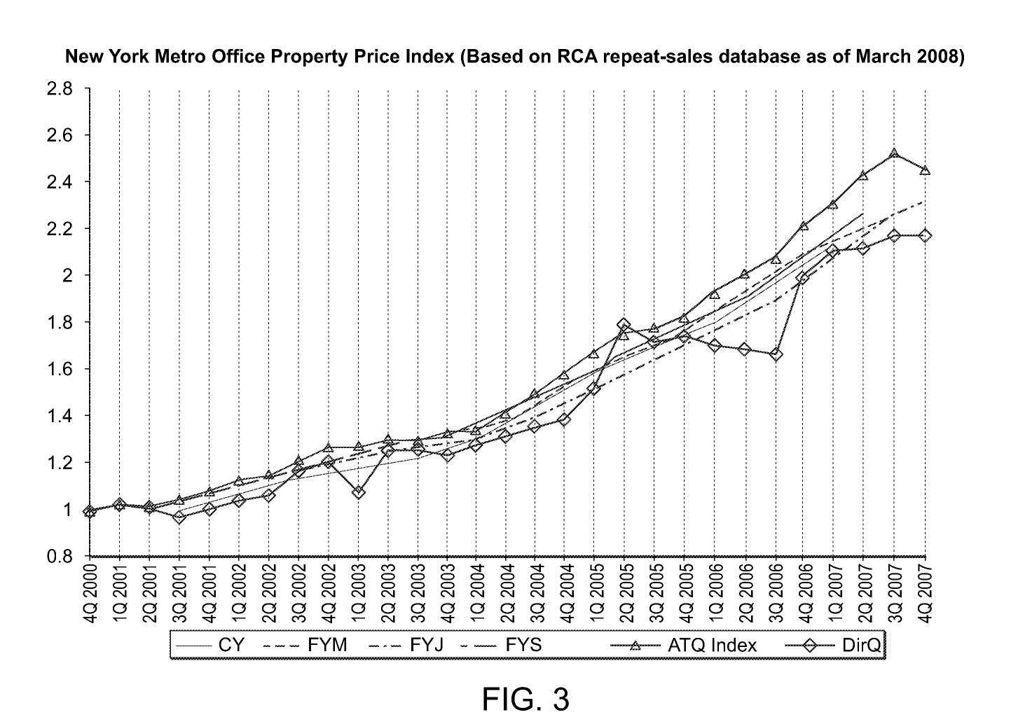

The New York office index is a good one to see the difference that can occur between direct quarterly estimation and the 2-stage ATQ. FIG. 3 shows these two alternative ways to estimate the index. Even though noise filtering is used in the direct quarterly estimation, this index (indicated by the line with diamonds) is clearly quite noisy, and differs markedly from the staggered annual indexes estimated from the same repeat-sales data. In FIG. 3 the staggered annual indexes are all presented with the convention of as starting at a value of unity (as in FIG. 1, but in contrast to FIG. 2). The direct quarterly index does not well represent what was going on in the New York metro region office market during the 2001-2007 period, especially in the sharp downtick in 2003Q1 and the long price slide from 2005Q2 through 2006Q3, a period which casual observation and the trade press would seem to indicate was one of robust growth in the New York office market. The staggered annual indexes and the ATQ do much better in representing the strong bull market of that period, and indeed in this particular case the ATQ seems to be about as good as the annual indexes, in addition to being more frequent. Note in particular the downturn in 2007Q4 picked up by the ATQ but not yet apparent in the annual indexes, a downturn consistent with the credit crunch of late 2007.

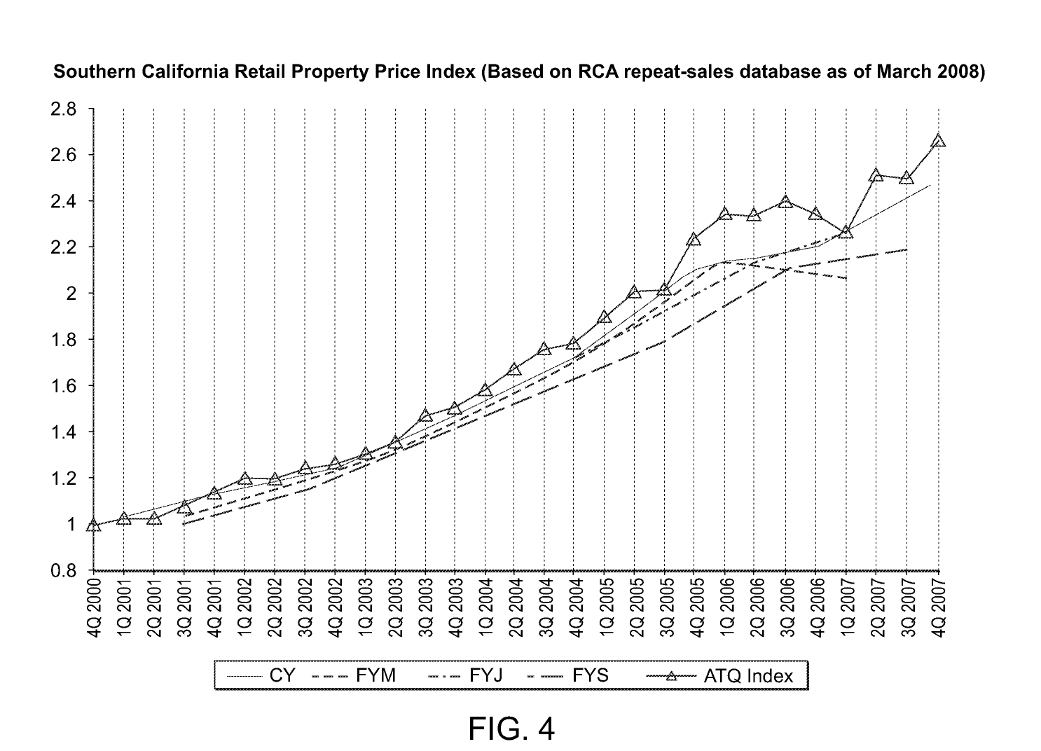

The Southern California (Los Angeles and San Diego metro areas) retail property index is a good one to see how the ATQ works, including both its strengths and weaknesses. FIG. 4 depicts the MPGIE-based ATQ (solid line with triangles) superimposed on its underlying staggered annual indexes (the same as were presented in FIG. 1) for the 2001Q1-2007Q4 period.

In FIG. 4, note how the ATQ is generally consistent with the annual returns that span each quarter. However, the quarterly index picks up the changes implied by changes in the staggered annual indexes. For example, while the FYS annual index ending in 2006Q4 was positive, it was less positive than the immediately preceding FYJ annual index ending in 2006Q3. (The FYS ending in 2006Q4 was up 4.6% but the FYJ ending in 2006Q3 was up 17.4%.) The resulting derived quarterly index indicated a downturn in 2006Q4 (−2.4%).

At first it may seem odd that the derived quarterly index can be negative when the annual indexes that span the quarter are all positive. The intuition behind a result such as the above example is that a subsequent annual index could still be increasing as a result of rises during the first 3 quarters of its 4-quarter time-span, with a drop in the last quarter that does not wipe out all of the previous three quarters' gains. For example, suppose the following are the true quarterly changes during the past 5 quarters: 07Q1=+3%, 07Q2=+3%, 07Q3=+3%, 07Q4=+3%, 08Q1=−4%. Then the CY07 annual index would show +12% (ending Dec. 31, 2007), and the FYM08 annual index would show +5% (ending Mar. 31, 2008), even though the 08Q1 quarterly return is negative. When the most recent annual index is rising at a lower rate than the next-most-recent annual index, it can (although does not necessarily) indicate that the most recent quarter was negative. The derived quarterly return (ATQ) methodology is designed to discover and quantify such situations as best we can. As noted, simple curve-fitting of the annual indexes introduces considerable smoothing, and will not be able to pick up in a timely manner the kind of turning points we have just described.

On the other hand, as we previously noted, the ATQ will have a lower signal/noise ratio than the underlying staggered annual return indexes from which it is derived. The result can be that each individual quarterly return is more prone to noise, possibly less meaningful, than is the case for each of the annual returns in the annual-frequency indexes. For example, in FIG. 4, look at the ATQ return for 2007Q2. The ATQ indicates a huge uptick in the that quarter of 10.9%. While the second quarter of 2007 was indeed the last period of the great bull market, it seems unlikely that market values really rose that much in a single quarter. The ATQ estimate of 10.9% may indeed make mathematical sense given that the FYJ annual index ending at the end of 2007Q2 rose 7.1% after the previous FYM annual index ending at the end of 2007Q1 actually declined by 3.5%. But those annual indexes are not without noise, and the effect of that noise may appear exaggerated in the ATQ estimate for 2007Q2.

The preceding material presented a concrete example of both the strengths and weaknesses of the 2-stage/frequency-conversion procedure for providing supplemental higher-frequency market information in small markets. We have suggested that the 2-stage procedure may tend to be better than direct (single-stage) high-frequency estimation, although we have not formalized that argument. Whether single-stage or two-stage estimation is more accurate depends on whether the second stage of regression adds less noise (and bias) than is removed by the effective increase in sample size presented by the staggered lower-frequency estimation in the first of the two stages. This may ultimately be an empirical question, and even if the 2-stage procedure does tend generally to be more accurate than direct high-frequency estimation, either procedure may be more accurate in a given specific empirical instance. In any case, the specific “errors” will differ across the two techniques, which suggests that there may be benefit in the information marketplace in producing and publishing both types of high-frequency indexes.

The RCA repeat-sales database and the Moody's/REAL Commercial Property Price Indexes present an opportunity to begin an empirical comparison of the two approaches. As noted, computation of index estimated returns standard errors is not straightforward for the ATQ, and “apples-to-apples” comparisons of estimated standard errors across the two procedures is not attempted in this disclosure. For one thing, consider that the second-stage regression itself has no residuals, as it makes a perfect fit to the staggered lower-frequency indexes that are its dependent variable. Furthermore, the objective of a price index regression is not the minimization of transaction price residuals per se, but rather the minimization of error in the coefficient estimates (the index's periodic returns). However, there are two statistical characteristics of an estimated market price index that can provide practical, objective information about the quality of the index. These two characteristics are the volatility and the first-order autocorrelation of the index's estimated returns series. Based on statistical considerations, we know that noise or error in the index returns will tend to increase the observed volatility in the index returns. And we know that noise or error will also tend to drive the index returns' first-order autocorrelation down, toward negative 50%. These are basic characteristics of the statistics of indexes. (See, e.g., Geltner & Miller et al (2007), Chapter 25.) Based on economic considerations, we know that the true quarterly volatility in commercial property market prices tends to be fairly low, and the true first-order autocorrelation tends to be at least slightly positive. Fundamentally, this is due to the relatively conservative, “cash-cow” nature of stabilized commercial property (the RCA-based indexes exclude leverage and development projects), and the relatively illiquid, sluggish nature of the private, search market in which property assets trade.

For example, the quarterly S&P/Case-Shiller home price index has volatility of only 1.7%, and first-order autocorrelation of 66%, from 1987 through 2007. While this may reflect greater sluggishness and “price stickyness” in housing markets compared to commercial property markets, and the NCREIF Property Index's quarterly volatility of 1.7% and first-order autocorrelation of 80% (1984-2007) may reflect appraisal smoothing, the transaction-price-based version of the NCREIF index produced by the MIT Center for Real Estate still only shows 3.8% quarterly volatility (with only 5% first-order autocorrelation).

Considering the foregoing, it would seem reasonable to compare the two index estimation methodologies based on the volatilities and first-order autocorrelations of the resulting estimated historical indexes. Lower volatility, and higher first-order autocorrelation, would be indicative of a “superior” index, that is, one that is likely to have less noise or error in its returns. For example, in the New York Office index that we considered in the previously in FIG. 3, the 2-stage (“ATQ”) index has 2.5% quarterly volatility, versus 6.8% in the directly-estimated (“DirQ”) index that seemed inferior. On the other hand, the Southern California Retail index that we considered in FIG. 4 as an example of noise in the ATQ has first-order autocorrelation of −22%, far below what is likely realistic for a real estate index.

Among the Moody's/REAL Commercial Property Price Indexes there are 16 indexes (including the New York Office and Southern California Retail indexes we have previously examined) that were originally published at only the annual frequency (with four staggered versions, as described above), because the available transaction price data was deemed to be insufficient to support quarterly estimation. An examination of the relative values of the volatilities and first-order autocorrelations resulting from estimation by the two alternative procedures across these 16 market segments can provide the beginnings of a quantitative comparison of the two procedures.

The 16 annual-frequency Moody's/REAL indexes include eight at the MSA level and eight at the multi-state regional level. The eight MSA-level indexes are: four different property sectors (apartment, industrial, office, retail) for Southern California (Los Angeles and San Diego combined), three other MSA-level office indexes (New York, Washington D.C., and San Francisco), and one apartment index (for Southern Florida, which combines Miami, Ft Lauderdale, West Palm Beach, Tampa Bay, and Orlando). The eight multi-state regional indexes include the four property sectors each within each of two NCREIF-defined regions: the East and the South. The East Region includes all the 15 states north and east of Georgia, Tennessee, and Ohio. The South Region includes the 9 states encompassed inclusively between Florida, Tennessee, Oklahoma, and Texas. There is thus some geographical overlap between the MSA-level and regional-level indexes, in the sense that three of the eight MSA-level indexes are also within two of the regional-level indexes. The New York and Washington D.C. office indexes are within the East Office regional index, and the South-Florida Apartments index is within the South Apartment regional index.

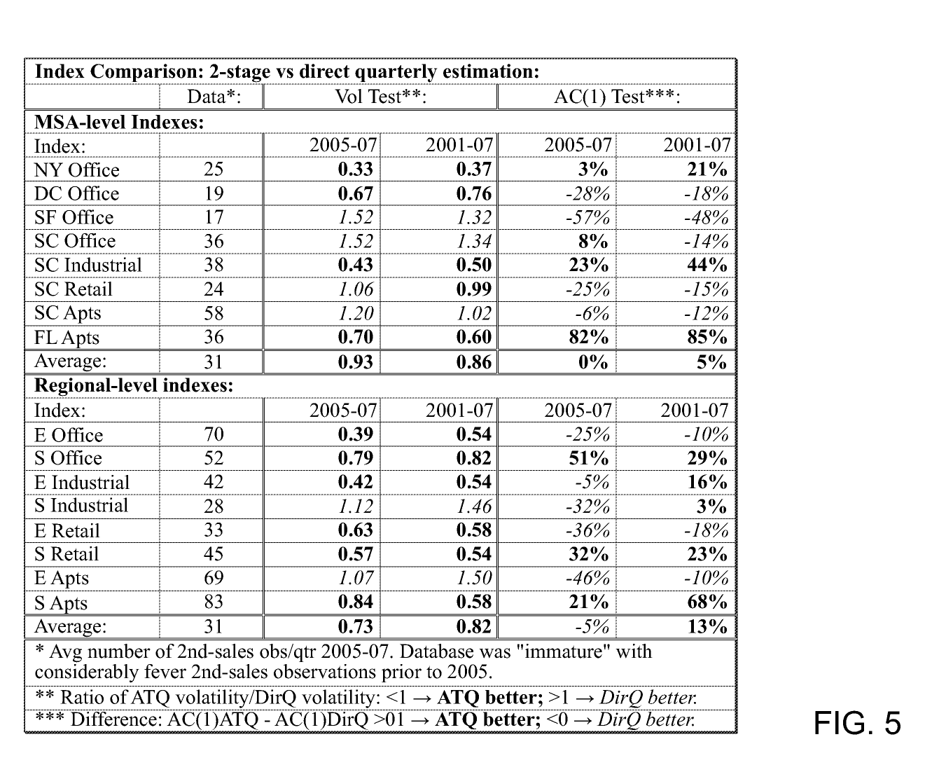

FIG. 5 summarizes the quantitative comparison based on the volatilities and first-order autocorrelations. The volatility test is defined by the ratio of the ATQ volatility divided by the DirQ volatility. The autocorrelation test is defined by the difference between the ATQ first-order autocorrelation minus that of the DirQ. Both tests are applied separately to the entire 28-quarter available history 2001-2007 and to the more recent 12-quarter period 2005-07. The RCA repeat-sales database “matured” to a considerable degree by 2005, with many more repeat-sales observations available since that time. The comparison is made for each of the 16 indexes and also averaged across the eight MSA-level and eight regional-level indexes. The overall impression left by this comparison is that neither quarterly index estimation method clearly dominates over the other. The ATQ procedure does seem to be slightly better, “winning” in more instances and in the overall averages. However, the DirQ procedure is superior in almost as many cases. In most markets, the two procedures are similar and any advantage seems to be slight.

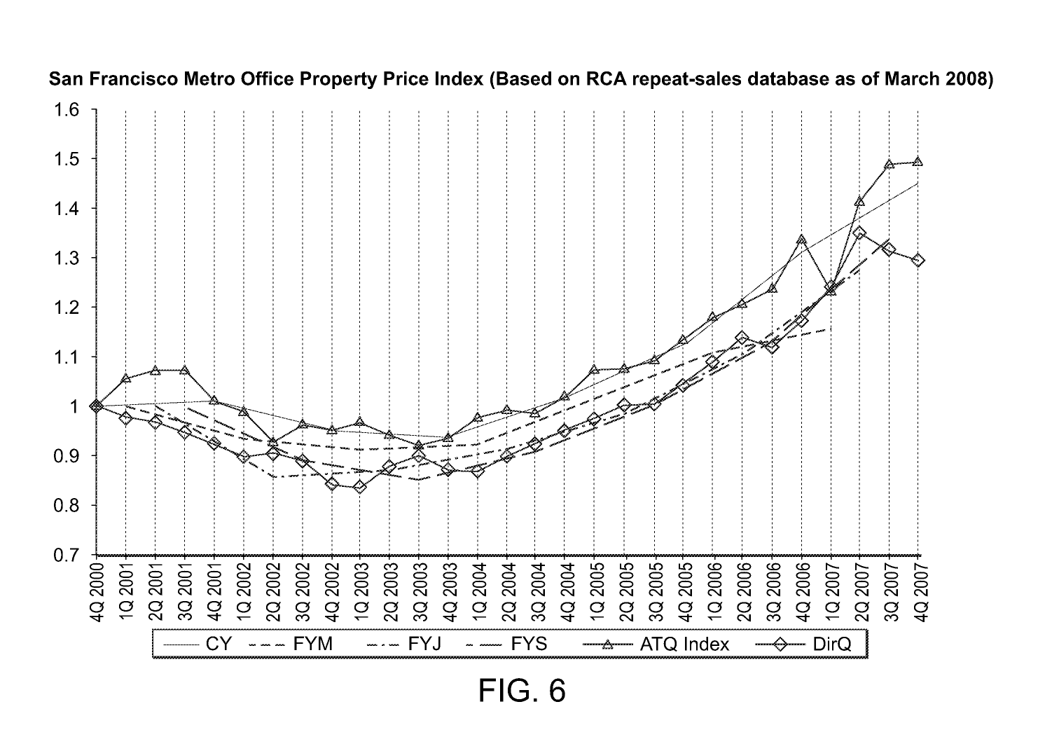

The worst case for the ATQ procedure (and best, relatively speaking, for the DirQ procedure) is the San Francisco Office index, which is shown for both the ATQ and the DirQ estimation in FIG. 6 (along with the underlying staggered annual-frequency indexes). While the ATQ index for San Francisco offices seems slightly inferior to the DirQ index in several ways (e.g.: unlikely small upsurge in the period of the “tech bust” in early 2001; lack of a downturn in the second half of 2007), the biggest problem with the ATQ results from a single quarter, 2007Q1, in which the ATQ somehow derives an anomalous downturn of −7.8% (the DirQ is positive 5.9% that quarter). The ATQ downturn is understandable in the underlying annual-frequency indexes: the CY index turned in a +16.5% return CY 2006, followed by the FYM index reporting only a +4.3% return for the four quarters ending in 2007Q1. But a little bit of positive noise in the CY2006 return followed by a little negative noise in the subsequent FYM return was apparently exaggerated in the ATQ derivation for 2007Q1.

We conclude this analysis of the MPGIE-based 2-stage/frequency-conversion procedure application to data-scarce markets with the general suggestion that the procedure can add value. It appears to be generally at least as good as direct quarterly estimation, and capable of adding information that the marketplace may be able to use. However, in data-scarce environments such as examined here (e.g., second-sales observational frequency averaging in the mid-20s per quarter), the ATQ is best used as a supplement to annual-frequency indexes, not a replacement, and indeed the ATQ may be supplemented also by direct quarterly estimation, as the two procedures may complement each other, each serving as a “cross-check” on the other.

We noted earlier that the two-stage/frequency-conversion procedure has two applications that are potentially of major interest for commercial property price indexes useful for supporting derivatives trading. In addition to the index reporting frequency enhancement that we have examined in the previous two sections, a second function applies not in particular to data-scarce environments, but rather to what are, in the real estate world, “high frequency” indexes, for practical purposes, the monthly frequency. At this frequency, the two-stage procedure can address a type of errors-in-variables problem that arises with the monthly time-dummy variables.

The nature of real estate transaction price data is that it is often possible to observe with a high degree of accuracy the date of the closing of the transaction. This observation of necessity becomes the date that governs the valuation of the monthly time-dummy corresponding to each transaction in index estimation. For example, consider the classical zero/one repeat-sale regression specification where the time-dummy coefficients are returns estimates. For a given observation, all of the monthly time-dummies from the month after the month of the first sale closing date up through (including) the month of the second sale closing date, will take on values of unity, and all other months' time-dummies will be set to zero for that observation. It has often been noted that there is a lag between the time when the actual, effective (economic) pricing decision was made for a given transaction and the subsequent closing date for that transaction. This lag obviously causes a type of lag in the index, in the sense that while the index measures returns based on realized closing dates, it is lagged behind pricing agreement dates. If the market effectively turns in September as reflected in prices agreed in deals struck in that month, but those deals do not close until November, then the index will not reflect the market turn until its report of the November return. Such a lag can be easily understood and dealt with in a derivatives market. But there is another, more subtle, problem.

The time lag between the effective price agreement date in the deal and the subsequent closing date varies randomly across transaction observations. It is this random variation in the closing lag that can cause a right-hand-side errors-in-variables effect in the regression estimation. While the time-dummy variables are observed with high accuracy for closing times, they reflect randomly-varying lags in relation to the actual (effective) price agreement times. It is well known that this type of errors-in-variables can cause attenuation bias in coefficient estimates, that is, a bias toward zero in the estimated coefficients. The random lag variation may be small relative to a year's span of time, but large relative to a month's span of time.

The traditional approach to deal with errors-in-variables is to find an instrumental variable that is highly correlated with the true variable and uncorrelated with the errors. In practice this approach is difficult to implement for commercial property price indexes. It is often difficult to obtain detailed property and transaction characteristics (other than price and closing dates), and indeed it may even be difficult conceptually to define the time when the effective price agreement is reached.

The two-stage/frequency-conversion procedure can address the errors-in-variables problem because, while the closing lag is random, it tends to be relatively short and well constrained, rarely more than 90 days and usually less than 60 days. Such a lag can have a major impact on monthly time-dummies, but much less impact on quarterly dummies (and of course even less on annual dummies). By estimating the index in a first stage at a lower frequency with staggered indexes, quarterly for example, and then applying the MPGIE frequency conversion procedure as described earlier, a monthly index can be derived with, in principle, much less errors-in-variables (e.g., approximately one-third as much in the quarterly-to-monthly conversion).

The errors-in-variables issue will be explored further in a simulation analysis to be completed in a subsequent research, but some indication of its nature can be obtained by examining an empirical example, again based on the RCA repeat-sales database. This time we use the entire U.S. commercial property repeat-sales database, aggregated across all four property type sectors, so that data scarcity is not an issue. (Since the beginning of 2005 there have been well over 200 2^{nd}-sale observations per month every month at the national aggregate level.)

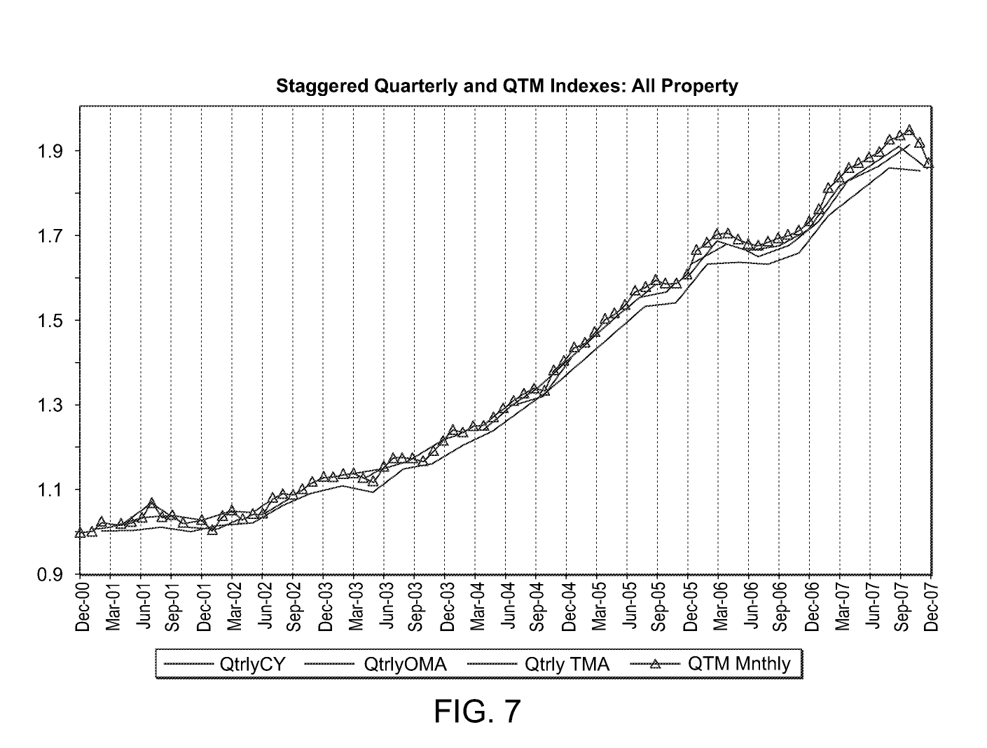

FIG. 7 depicts the 2-stage MPGIE-based monthly-frequency index (labeled “QTM”, for Quarterly-to-Monthly) superimposed on the three underlying staggered quarterly indexes from which it is derived. These are labeled: “CY”, corresponding to the calendar quarters; “OMA” commencing one month after the CY index; and “TMA” commencing two months after (or equivalently ending one month before) the CY index. FIG. 7 is similar to FIG. 4 only going from quarterly to monthly rather than annual to quarterly, and in a much more data-rich environment. The derived monthly index is seen to behave in a logical manner relative to changes in the underlying quarterly indexes.

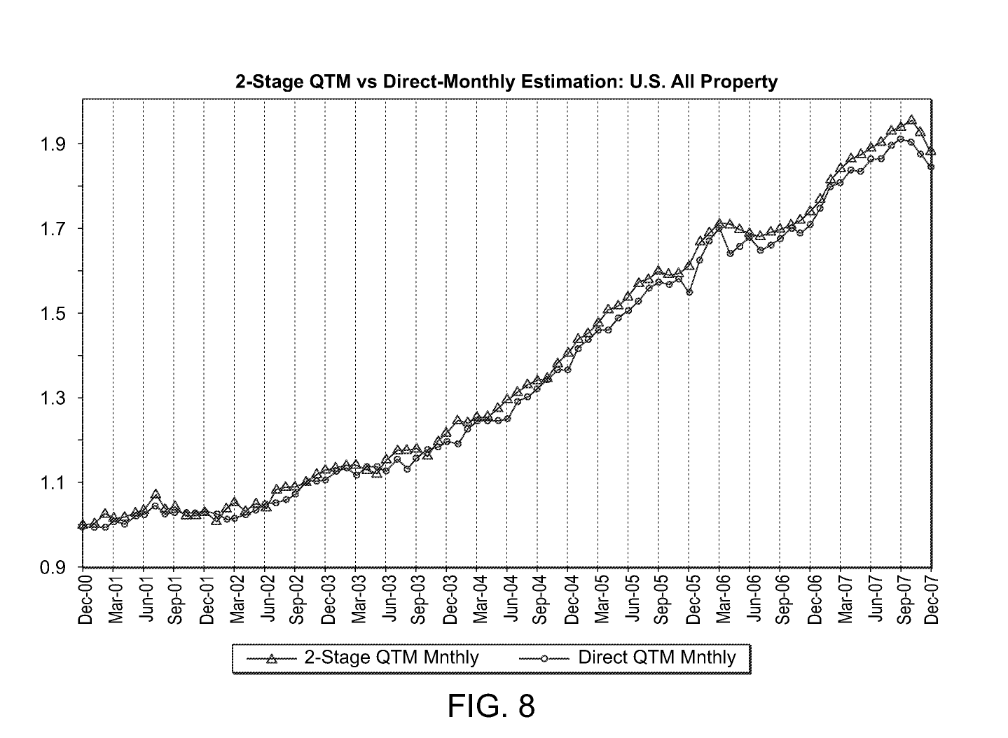

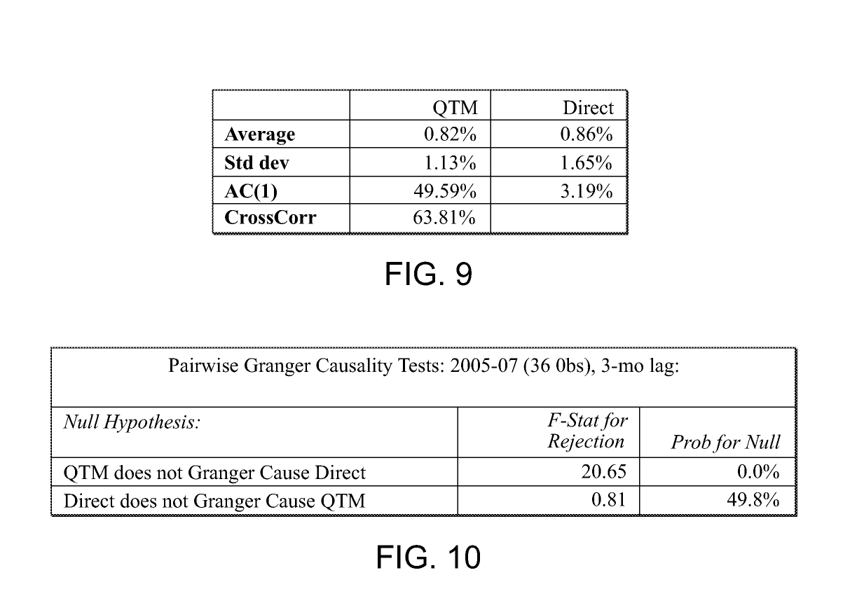

FIG. 8 depicts the 2-stage QTM index and the corresponding direct-monthly index both at the monthly frequency and based on the same repeat-sales database (indexes through December 2007 based on observations available by February 2008). The QTM index appears less “choppy” than the direct-monthly index, indicating less noise. This is confirmed statistically in the table in FIG. 9, which presents monthly return statistics for the two indexes for the three years from beginning of 2005 through 2007. As noted, in the RCA repeat-sales database there are considerably fewer second-sale observations prior to 2005. Our focus in the present section is on a data-rich environment for the index estimation. The QTM has lower volatility and higher first-order autocorrelation, both indicators of less noise in the index. While the high positive autocorrelation in the 2-stage QTM might suggest a lag, and there is some visual suggestion of this based on the timing of the late-2007 downturn (direct index turned down in October, QTM not until November), in fact Granger Causality tests strongly support the hypothesis that the QTM leads the direct-monthly index with at least a three months of statistically significant lead, as reported in FIG. 10. The positive serial correlation in the QTM index may simply reflect the nature of price discovery in a relatively illiquid private search market such as that in which real estate assets trade. By this reasoning, the lower serial correlation in the directly-estimated monthly index would simply reflect noise. However, we must recognize that three years is a very short history from which to gauge typical real estate market serial correlation, especially as the years in question were dominated by a strong bull market.

While the theoretical considerations previously described suggest that the QTM procedure addresses attenuation bias that could be caused by errors-in-variables, it is interesting to note that the comparison of quarterly versus monthly estimation in FIG. 8 does not suggest that attenuation bias has been much of an issue in the RCA database. If it were, then we would see the direct-monthly index trending substantially and steadily “flatter”, that is, less positive growth during “up-markets” and less downward drop during “down-markets”, with in fact there having been very little of the latter in the available history. But FIG. 8 reveals only a slight attenuation in the long-term average growth trend of the direct-monthly index compared to the staggered quarterly indexes or to the QTM. Over the 84-month history since 2000, a period dominated by positive price appreciation, the direct-monthly index has only two basis-points per month lower average growth than the QTM.

This specification has described a methodology for estimating higher frequency (e.g., quarterly) price indexes from staggered lower-frequency (e.g., annual) indexes. There are two major potential practical applications: to provide supplemental higher-frequency information about market movements in data-scarce environments that require low-frequency indexes; and to address a right-hand-side errors-in-variables problem (as well as improve efficiency) in high-frequency (in particular, monthly) indexes in a data-rich environment. The 2-stage approach takes advantage of the lower frequency to, in effect, accumulate more data over the longer-interval time periods which can be used to estimate returns with less error. Then a frequency conversion procedure is applied using the Moore-Penrose pseudoinverse matrix in an under-identified second-stage “repeat-sales” regression in which the staggered low-frequency indexes provide the “repeat-sales” data inputs. Linear algebra theory establishes that this frequency conversion procedure is optimal in the sense that it minimizes the variance and bias added in the second stage. Numerical simulation suggests that the noise and bias added in the second stage may indeed be small.

The result is a higher-frequency index that, while it has a signal/noise ratio lower than the underlying low-frequency indexes, nevertheless adds higher frequency information that may be useful in the marketplace, especially in the context of tradable derivatives. Empirical analysis suggests that the 2-stage procedure will often produce indexes that have lower volatility and/or higher first-order autocorrelation than directly-estimated high-frequency indexes, suggesting that the 2-stage procedure may tend to be more efficient at least in some cases and may be able to provide useful supplemental information in the marketplace. In a comparison across 16 indexes in data-scarce environments the 2-stage procedure outperforms direct estimation in the majority of the cases, and in a comparison in a high-frequency, data-rich application the 2-stage procedure also seems superior to direct estimation.

### APPENDIX A

### The Moore-Penrose Pseudoinverse or the Generalized Inverse

The Moore-Penrose pseudoinverse is a general way of solving the following system of linear equations:

y=Xb, yεRⁿ; bεR^{k}; XεR^{n×k} (1)

It can be shown that there is a general solution to these equations of the form:

b=X^{†}y (2)

The X^{†} matrix is the unique Moore-Penrose pseudoinverse of X that satisfies the following properties:
1. X X^{†}X=X (X X^{†} is not necessarily the identity matrix)
2. X^{†}X X^{†}=X^{†}
3. (X X^{†})^{T}=X X^{†} (X X^{†} is Hermitian)
4. (X^{†}X)^{T}→X^{†}X (X^{†} X is also Hermitian)

The solution given by equation (2) in the previous Appendix is a minimum norm least squares solution. When X is of full rank (i.e., rank is at most min(n, k)), the generalized inverse can be calculated as follows:

Case 1: When n=k (same number of equations as unknowns): X^{†}=X⁻¹
Case 2: When n<k (fewer equations than unknowns): X^{†}=X^{T}(X X^{T})⁻¹
Case 3: When n>k (more equations than unknowns): X^{†}=(X^{T} X)⁻¹ X^{T}

In the application for deriving quarterly indexes from staggered annual indexes, Case 2 provides the relevant calculation. Furthermore, it should be noted that when the rank of X is less than k, no unbiased linear estimator, b, exists. However, for such a case, the generalized inverse provides a minimum bias estimation. Properties of the generalized inverse can be found in Penrose (1954) and equation (2) first appeared in Penrose (1956). Proofs of Cases 1-3 can be found in Albert (1972) and a proof of minimum biasedness is given in Chipman (1964). For the basic references on the Moore-Penrose pseudoinverse see the references by Penrose (1955, 1956), Chipman (1964), and Albert (1972) in the bibliography.

### APPENDIX B

### A Note on Bias in the Moore-Penrose Frequency Conversion

Here we consider the case relevant to our present purposes, i.e. where X^{†}=X^{T} (X X^{T})⁻¹. Therefore, in our application, the solution (or estimation) of the second-stage regression (equation (2) of Appendix A) can be re-written as:

b=X^{T}(XX^{T})⁻¹y

Considering that the true value of the predicted variable (y) is by definition: Xb_{True}, therefore the expected value of b is:

E[b|X]=X^{T}(XX^{T})⁻¹Xb_{True}

Let R=X^{T} (X X^{T})⁻¹ X be the “resolution” matrix, which would have otherwise been the k by k identity (I) matrix if X had been of full column rank. In our case, the resolution matrix is instead a symmetric matrix describing how the generalized inverse solution “smears” out the b_{True} into a recovered vector b. The bias in the generalized inverse solution is

$$\begin{matrix}E [ b \vert X ] - {b}_{True} = R {b}_{True} - {b}_{True} \\ = ( R - I ) {b}_{True}\end{matrix}$$

We can formulate a bound on the norm of the bias:

∥E[b|X]−b_{True}∥≦∥R−I∥∥b_{True}∥

Computing ∥R−I∥ can give us an idea of how much bias has been introduced by the generalized inverse solution. However, the bound is not very useful since we typically have no knowledge of ∥b_{True}∥.

In practice, we can use the resolution matrix, R, for two purposes. First, we can examine the diagonal elements of R. Diagonal elements that are close to one correspond to coefficients for which we can expect good resolution. Conversely, if any of the diagonal elements are small, then the corresponding coefficients will be poorly resolved. Secondly, we can multiply R times a particular test coefficient vector bₜₑₛₜ to see how the vector would resolve in the inverse solution b. This strategy is called the “resolution test”. One commonly used test in the geophysics literature is a “spike model”, which is a vector of coefficients with all zero elements, except for one single entry, which is one. Multiplying R times a spike coefficient vector effectively picks out the corresponding column of the resolution matrix.

### BIBLIOGRAPHY

Albert, A. (1972). Regression and the Moore-Penrose Pseudoinverse. Academic Press, New York.
Aster, R. C, Borchers, B. and Thurber, C. H. (2005). Parameter Estimation and Inverse Problems. Elsevier Academic Press
T. Bryan & P. Colwell, “Housing Price Indices”, in C. F. Sirmans (ed.), Research in Real Estate, vol. 2. Greenwich, Conn.: JAI Press, 1982.
Chipman, J. (1964). On Least Squares with Insufficient Observations. Journal of the American Statistical Association 59, No. 208, 1078-1111
J. Clapp, “A Semiparametric Method for Estimating Local House Price Indices”, Real Estate Economics 32(1): 127-160, 2004.
D. Geltner & D. Ling, “Considerations in the Design & Construction of Investment Real Estate Research Indices”, Journal of Real Estate Research, 28(4):411-444, 2006.
D. Geltner, N. Miller, J. Clayton, & P. Eichholtz, Commercial Real Estate Analysis & Investments 2^{nd} Edition, South-Western College Publishing Co/Cengage Learning, Cincinnati, 2007.
D. Geltner & H. Pollakowski, “A Set of indexes for Trading Commercial Real Estate Based on the Real Capital Analytics Transaction Prices Database”, MIT Center for Real Estate, Commercial Real Estate Data Laboratory—CREDL, Release 2 (September 2007). Downloadable from: http://web.mit.edu/cre/research/credl/rca.html.
W. Goetzmann, “The Accuracy of Real Estate Indices: Repeat-Sale Estimators”, Journal of Real Estate Finance & Economics 5(1): 5-54, 1992
D. McMillen & J. Dombrow, “A Flexible Fourier Approach to Repeat Sales Price Indexes”, Real Estate Economics 29(2): 207-225, 2001.
Pace, R K & J P LeSage, “Spatial Statistics and Real Estate”, Journal of Real Estate Finance and Economics, 29(2):147-148, 2004.
Penrose, R. (1955), “A Generalized Inverse for Matrices”, Proceedings of the Cam bridge Philosophical Society 51, 406-413
Penrose, R. (1956), “On best approximate solutions of linear matrix equations”, Proceedings of the Cambridge Philosophical Society 51, 17-19
Schwann, G. (1998), “A Real Estate Price Index for Thin Markets”, Journal of Real Estate Finance & Economics 16(3): 269-2

What is claimed is:

1. Method for generating a higher frequency tradable index of real estate price movements comprising:
running a first stage regression to optimize a real estate price change index at a sufficiently low frequency to eliminate most noise to generate a low frequency index;
producing a series of the low frequency indexes in different versions that have regularly staggered starting dates corresponding to the frequency of a desired higher frequency index; and
running a second stage regression employing the Moore-Penrose Generalized Inverse Estimator to convert the staggered series of low frequency indexes to the higher frequency index.

2. The method of claim 1 wherein the low frequency index is generated annually and the higher frequency index is generated quarterly.
